(19) United States
(12) Patent Application Publication
(10) Pub. No.: US 2021/0314375 A1
(43) Pub. Date: Oct. 7, 2021

(54) MODERATOR CHANGE FOR AN EXISTING MEETING INVITE

(71) Applicant: Avaya Management L.P., Santa Clara, CA (US)

(72) Inventor: Tanvi Sharma, Pune (IN)

(21) Appl. No.: 16/872,768

(22) Filed: May 12, 2020

(30) Foreign Application Priority Data
Apr. 3, 2020 (IN) 202011014869

(51) Int. Cl. H04L 29/06; G06Q 10/10; G06F 21/60

(52) U.S. Cl. CPC H04L 65/4038; G06F 21/604; G06Q 10/1095

(57) ABSTRACT

The technology disclosed herein enables the moderator of a meeting invite to be changed to a different moderator. In a particular embodiment, a method provides, in a meeting control system, receiving a first request to change a moderator of a first meeting invite. The first meeting invite includes two or more participants and the two or more participants include a first moderator indicated for the first meeting invite. In response to determining that the first request is associated with a user allowed to change the moderators of the first meeting invite, the method provides modifying the first meeting invite to indicate a second moderator for the first meeting invite and including the second moderator in the two or more participants.

### RELATED APPLICATIONS

This application claims the priority and benefit under 35 U.S.C. 119(a)-(d) to Foreign Application Serial No. 202011014869 filed in India entitled “MODERATOR CHANGE FOR AN EXISTING MEETING INVITE”, on Apr. 3, 2020, which is herein incorporated in its entirety by reference for all purposes.

### TECHNICAL BACKGROUND

Meeting control systems maintain information for meetings scheduled between two or more people. A meeting may be held in-person, remote (e.g., using a conferencing bridge), or may be a combination thereof. Each meeting is managed using what is commonly called a meeting invite, which is created by a participant who will be the moderator of the meeting. The meeting invite includes details of the meeting including meeting title, meeting time, meeting location, participants, conference bridge information, electronic documents or other media relevant to a topic of the meeting, and/or other information relevant to a meeting. The meeting invite is typically forwarded to the identified participants and, should a participant accept the meeting invite, a calendar entry for the meeting is created in the participant's electronic calendar. If the moderator cannot attend the meeting after creating the invite, or it has otherwise been determined that another person should be the moderator, the moderator would need to cancel the meeting invite and have the new moderator create a new invite.

### SUMMARY

The technology disclosed herein enables the moderator of a meeting invite to be changed to a different moderator. In a particular embodiment, a method provides, in a meeting control system, receiving a first request to change a moderator of a first meeting invite. The first meeting invite includes two or more participants and the two or more participants include a first moderator indicated for the first meeting invite. In response to determining that the first request is associated with a user allowed to change the moderators of the first meeting invite, the method provides modifying the first meeting invite to indicate a second moderator for the first meeting invite and including the second moderator in the two or more participants.

In some embodiments, the method provides synchronizing the first meeting invite with endpoints of the two or more participants.

In some embodiments, the method provides notifying the two or more participants about the second moderator.

In some embodiments, the method provides establishing a first communication session between respective endpoints of the two or more participants.

In some embodiments, the method provides after modifying the first meeting invite, removing the first moderator from the two or more participants of the first meeting invite.

In some embodiments, the method provides, after modifying the first meeting invite, the first meeting invite indicates both the first moderator and the second moderator are the moderators for the first meeting invite.

In some embodiments, the method provides, before modifying the first meeting invite, receiving confirmation of the first request from the second moderator.

In some embodiments, the method includes providing moderator-level permissions for accessing the first meeting invite to the second moderator.

In some embodiments, the user is the first moderator.

In some embodiments, the user is not one of the two or more participants.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to receive a first request to change a moderator of a first meeting invite. The first meeting invite includes two or more participants and the two or more participants include a first moderator indicated for the first meeting invite. In response to determining that the first request is associated with a user allowed to change the moderators of the first meeting invite, the program instructions direct the processing system to modify the first meeting invite to indicate a second moderator for the first meeting invite and include the second moderator in the two or more participants.

### BRIEF DESCRIPTION OF THE DRAWINGS

FIG. 1 illustrates an implementation for changing the moderator on an existing meeting invite.

FIG. 2 illustrates an operational scenario to change the moderator on an existing meeting invite.

FIG. 3 illustrates another operational scenario to change the moderator on an existing meeting invite.

FIG. 4 illustrates another implementation for changing the moderator on an existing meeting invite.

FIG. 5 illustrates an operational scenario to change the moderator on an existing meeting invite.

FIG. 6 illustrates another operational scenario to change the moderator on an existing meeting invite.

FIG. 7 illustrates a meeting invite version for changing the moderator on an existing meeting invite.

FIG. 8 illustrates another meeting invite version for changing the moderator on an existing meeting invite.

FIG. 9 illustrates another operational scenario to change the moderator on an existing meeting invite.

FIG. 10 illustrates a computing architecture for changing the moderator on an existing meeting invite.

### DETAILED DESCRIPTION

The process of creating a new meeting invite to change the moderator of a previous meeting invite causes the meeting participants to be notified of the old meeting invite's cancellation and of the creation of the new meeting invite from the new moderator, which each participant will again have to accept to include in their respective electronic calendars. Those notifications are no different from those that are sent for the cancelation of one meeting and creation of another, unrelated, meeting despite the new meeting invite being an invite corresponding to the same meeting but with a different moderator. In addition to causing unnecessary steps for a participant to maintain what is essentially the same meeting in their calendar, the creation of the new meeting invite may remove any reservations, such as physical meeting room, equipment, or conference bridge resource reservations, or additional data, such as media or documents, tied to the original meeting invite. The new moderator would have to hope that the same or comparable reservations are still available when creating the new meeting invite (e.g., a meeting room may have a waitlist that automatically goes to the next request in line upon cancelation of a meeting) and would have to obtain the additional data for inclusion in the new meeting invite. The examples below avoid having to create a new meeting invite when the moderator of a meeting invite needs to be changed. Instead, the information identifying and related to the moderator on the meeting invite is changed in the meeting invite to indicate the new moderator. The changes are then synchronized to the electronic calendars of the meeting participants without requiring the participants to accept a new meeting invite from the new moderator.

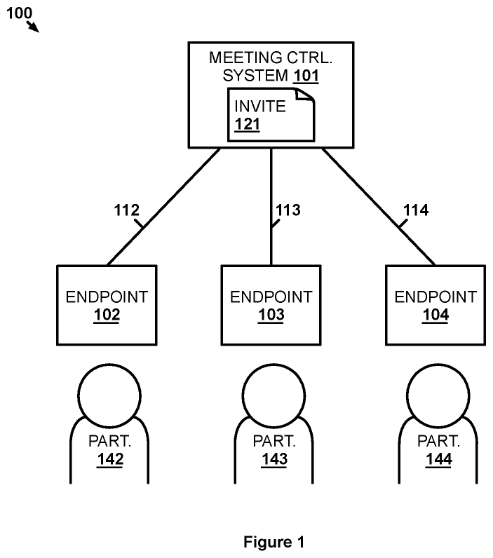

FIG. 1 illustrates implementation 100 for changing the moderator on an existing meeting invite. Implementation 100 includes meeting control system 101, endpoint 102, endpoint 103, and endpoint 104. Meeting control system 101 and endpoints 102-104 communicate over communication links 112-114, respectively. Communication links 112-114 may comprise wireless and/or wired communication links and may include intervening communication networks, systems, and devices. Endpoints 102-104 may each comprise a wired phone, wireless phone, desktop workstation, laptop computer, tablet computer, conference room communication system, or any other type of user system or device capable of exchanging data communications with meeting control system 101.

In operation, endpoints 102-104 are operated by users that are, or will be, participants 142-144, respectively, in the meeting of meeting invite 121. Meeting control system 101 maintains meeting invite 121 and controls meeting invite 121's distribution to participants 142-144 via the respectively endpoints 102-104 of participants 142-144. Meeting control system 101 may further maintain electronic calendars (e.g., meetings, appointments, reminders, etc.) for each of participants 142-144 or may use meeting invite 121 to provide meeting information another system, or other systems, that maintains the respective calendars of participants 142-144. In this example, meeting invite 121 was created by participant 142 as the moderator and participant 143 and participant 144 were indicated as participants. Participant 143 and participant 144 received and accepted meeting invite 121 via respective endpoints 103 and 104. Other endpoints may be used to receive and accept meeting invites (e.g., a participant may have a phone and a computer that are both capable of handling meeting invites and the participant may accept the invite via the phone but participate in the meeting via the computer) but only one endpoint is shown in this example for simplicity. This example includes three participants for meeting invite 121 but any number of two or more participants may participate in a meeting and, therefore, be included on a meeting invite.

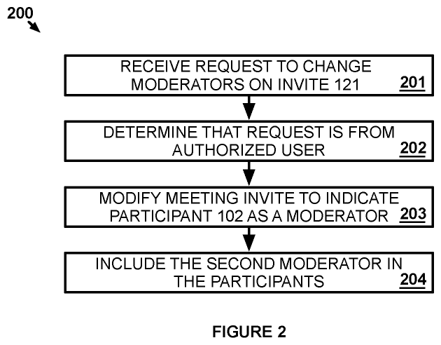

FIG. 2 illustrates operational scenario 200 to change the moderator on an existing meeting invite. Meeting control system 101 receives a request to change the moderator of meeting invite 121 (201). In this example, the request is received from participant 142, who is the current moderator on meeting invite 121, via endpoint 102 and indicates that participant 143 should be the new moderator on meeting invite 121. For instance, when participant 142 determines that someone else should be the moderator on meeting invite 121, participant 142 may open a calendar application, or a calendar web app in a web browser window, on endpoint 102 that communicates with meeting control system 101 and allows participant 142 to edit the details of meeting invite 121. Participant 142 may then edit meeting invite 121 to indicate participant 143 as being the new moderator. After editing, or upon endpoint 102 receiving instructions from participant 142 to save the changes made to meeting invite 121, the request is sent to meeting control system 101.

Before changing moderators, meeting control system 101 determines whether the request is associated with a user allowed to change the moderators of meeting invite 121 (202). In this example, the request is associated with participant 142, who is the current moderator, and is, therefore, allowed to edit meeting invite 121 in any way participant 142 sees fit, including changing the moderator. Other users may also be allowed to change the moderators, such as an administrator of meeting control system 101 or a supervisor of participants 142-144. For example, if participant 142 is unavailable to change moderators, then participant 142's supervisor may also change moderators of meeting invite 121. In some examples, the determination of whether a user is allowed to change moderators may be made before receiving the request. For instance, if a user is unable to change moderators, then that user may not be given the option to edit the moderator in meeting invite 121 when accessing meeting invite 121 via the user's endpoint. Since participant 142 is allowed to change moderators in this example, participant 142 was given the option to change moderators on meeting invite 121.

In response to determining that the request is associated with a user allowed to change the moderators of meeting invite 121 (i.e., participant 142 in this example), meeting control system 101 modifies meeting invite 121 to indicate participant 143 is the moderator of meeting invite 121 (203). For example, in the data object representing meeting invite 121 in meeting control system 101, meeting control system 101 changes the information indicating participant 142 as being the moderator to instead indicate the participant 143 is the moderator. In some examples, meeting invite 121 may include a moderator field having the identity of participant 142 replaced with the identity of participant 143 (e.g., name, username, and/or email address of participant 142 gets replaced with the name, username, and/or email address of participant 143). Alternatively, meeting invite 121 may include a list of all participants 142-144 and may simply associate a data flag indicating the moderator with one of the participants. In that case, meeting control system 101 may change the data flag from being associated with participant 142 to being associated with participant 143. Other manners of formatting the data of meeting invite 121 to indicate a moderator can also be used. In some cases, meeting control system 101 may store meeting invite 121 in a storage location (e.g., file folder) associated with the moderator of meeting invite 121. In those cases, meeting control system 101 may also move meeting invite 121 from a location associated with participant 142 to a location associated with participant 143. In some examples, meeting control system 101 may transfer a request to participant 143 that asks participant 143 to confirm that they are willing to become a moderator of meeting invite 121. For example, meeting control system 101 may transfer a notification to endpoint 103 that cause endpoint 103 to request user input from participant 143 to confirm that participant 143 is willing to be the moderator on meeting invite 121.

Meeting control system 101 further includes participant 143 in the participants of meeting invite 121 (204). In this example, participant 143 was a participant on meeting invite 121 prior to becoming the moderator of meeting invite 121. Thus, including participant 143 in the participants of meeting invite 121 simply means participant 143 remains a participant. In other examples, the new moderator may not have already been a participant on meeting invite 121 and, therefore, would need to become a participant. If meeting invite 121 has a data field for a moderator that is separate from the rest of the participants, then that the new moderator will also be included in the rest of the participants. In some cases, indicating that the new moderator is a moderator may default to including the new moderator in the participants of meeting invite 121. Thus, depending on how meeting invite 121 is structured, meeting control system 101 may need to perform different actions to ensure the new moderator is included in the participants on meeting invite 121.

In this example, participant 142 remains a participant on meeting invite 121. As such, meeting control system 101 may need to indicate within meeting invite 121 that participant 142 is a participant once participant 142 is no longer indicated as being a moderator. For instance, if the moderator is indicated separate from a participant list in meeting invite 121, meeting control system 101 may move the identifier of for participant 142 to the participant list to indicate that participant 142 is still a participant. In other examples, participant 142 may no longer be a participant on meeting invite 121 and, if removing participant 142 as moderator does not also remove participant 142 as a participant, then meeting control system 101 will remove them as a participant on meeting invite 121 as well.

Advantageously, upon completion of operational scenario 200 meeting invite 121 remains intact and merely indicates a different moderator. As such, any data attached to meeting invite 121, such as documents or media, any reservations associated with meeting invite 121, such as meeting rooms or equipment (e.g., projectors, cameras, etc.), or anything else that can be associated with a meeting invite, remain attached to, or otherwise associated with, meeting invite 121 instead of being lost if meeting invite 121 was canceled or deleted by participant 142. Likewise, endpoints 102-104 do not receive meeting cancelation notifications for meeting invite 121 and requests to accept an invite to a new meeting in place of meeting invite 121, as would have occurred if meeting control system 101 was not able to perform operational scenario 200. After operational scenario 200, meeting invite 121 is treated, effectively, as though participant 143 had created meeting invite 121 instead of participant 142 and participant 143 is afforded all moderator permissions accordingly (e.g., permissions to edit, delete, invite participants, and/or perform some other type of modification to meeting invite 121).

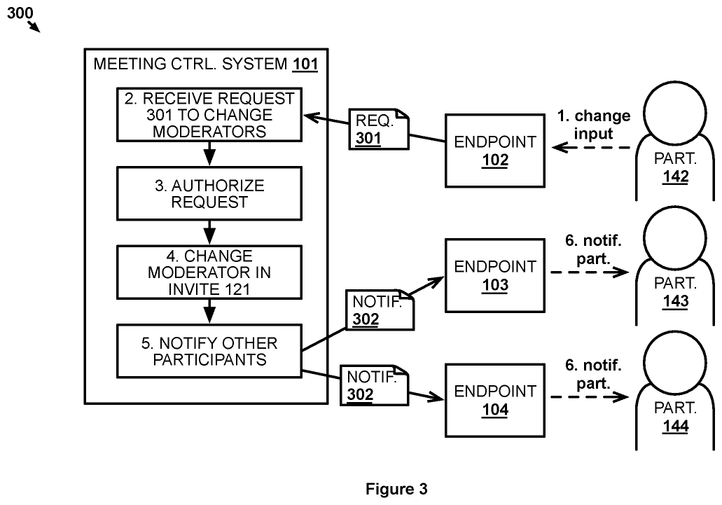

FIG. 3 illustrates operational scenario 300 to change the moderator on an existing meeting invite. Operational scenario 300 is another example of how participant 142 would change the moderator of meeting invite 121 to participant 143. In this example, participant 142 provides user input into endpoint 102 at step 1 that directs endpoint 102 to request a modification to meeting invite 121. The input may be provided to an application, either natively executing or web-based, on endpoint 102, such as a calendar or collaboration application that has capabilities to modify meeting invite 121. The input from participant 142 causes endpoint 102 (e.g., at the instruction of the application) to transfer modification request 301. Modification request 301 may be a message in a format defined by a protocol used by meeting control system 101 for interacting with meeting control system 101 to modify meeting invites. In some examples, endpoint 102 may store a copy of meeting invite 121 locally and may apply modifications to meeting invite 121 locally. In those examples, modification request 301 may include the modified copy of meeting invite 121 such that meeting control system 101 can synchronize its own copy of meeting invite 121 with the changes in the copy of meeting invite 121 from endpoint 102.

Meeting control system 101 receives modification request 301 from endpoint 102 at step 2 and authorizes modification request 301 at step 3. In particular, meeting control system 101 determines whether participant 142 is authorized to modify meeting invite 121 before allowing the modifications requested by modification request 301. In this case, a current moderator of a meeting invite is allowed to modify that meeting invite. Since participant 142 is the current moderator of meeting invite 121, requests to modify the moderator of meeting invite 121 from participant 142 are allowed. Accordingly, meeting control system 101 complies with modification request 301 and changes the moderator of meeting invite 121 at step 4 from participant 142 to participant 143. Meeting control system 101 changes anything in the data representing meeting invite 121 that needs to be changed such that meeting invite 121 now reflects participant 143, not participant 142, as being the moderator of meeting invite 121. In some examples, meeting control system 101 may also change any reservations associated with meeting invite 121 to indicate participant 143 as now being the moderator. Although, if changing the moderator with respect to a particular reservation would adversely affect the reservation (e.g., cancel the reservation in favor of someone on a waitlist for the reservation), then meeting control system 101 may leave participant 142 on that reservation so as not to lose the reservation for meeting invite 121.

After changing the moderator to participant 143, meeting control system 101 notifies participant 143 and participant 144 about the moderator change at step 5 by transferring modification notification 302 to endpoint 103 and endpoint 104. Modification notification 302, like modification request 301, may also be transferred in a format defined by meeting control system 101. For example, a protocol used by meeting control system 101 (and applications executing on endpoints 102-104) may define how update messages should be transferred. In this case, receipt of modification notification 302 triggers endpoint 103 and endpoint 104 to notify their respective participants 143 and 144 at step 6 that participant 143 is now the moderator of meeting invite 121. For example, endpoint 103 and endpoint 104 may display a popup notification (possibly along with a vibration or ring tone) that participant 143 is now the moderator of meeting invite 121. The popup may be similar to a popup that would be displayed for other modifications to meeting invite 121 (e.g., if the time for meeting invite 121 was changed). Therefore, participant 143 and participant 144 are still notified that the moderator of meeting invite 121 has changed even though a new meeting invite did not need to be created with participant 143 as the moderator thereof.

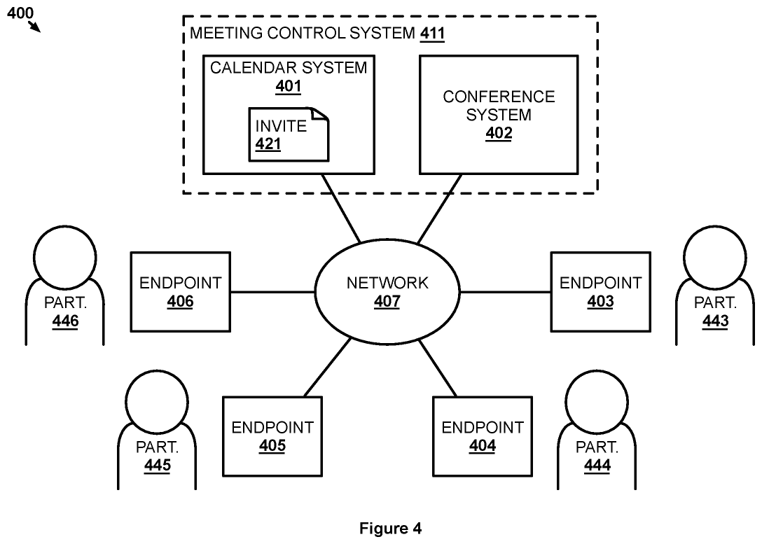

FIG. 4 illustrates implementation 400 for changing the moderator on an existing meeting invite. Implementation 400 includes calendar system 401, conference system 402, endpoints 403-406, and communication network 407. Communication network 407 may include one or more local area networks and/or wide area computing networks, including the Internet, over which the systems in implementation 400 communicate. In this example, calendar system 401 and conference system 402 in combination are considered meeting control system 411. In other examples, the features of calendar system 401 and conference system 402 may be distributed differently between one or more systems. For example, meeting control system 411 may be part of a services platform (e.g., conferencing, messaging, and/or calendar services) that provides those services using any number of systems and devices.

In operation, calendar system 401 hosts the respective electronic calendars for participants 443-446. In other examples, the calendars of one or more of participants 443-446 may be hosted by other calendar systems. For instance, calendar system 401 may be operated by an entity the employee participant 443 and participant 444 and, therefore, hosts the calendars of those two participants. An employer of participant 445 and participant 446 may operate its own calendar system that hosts the calendars of those two participants. That other calendar system would be configured (e.g., use the same calendar protocols) such that it can handle meeting invites (and any modifications to those invites) received by participant 445 and participant 446 via their respective endpoints 405 and 406.

Conference system 402 facilitates remote meetings between endpoints via conference sessions. A conference session may exchange media (e.g., audio, video, and/or text) representing user communications between participants in a conference session. The conference session may also exchange other media on behalf of participants, such as a shared desktop or application window, documents, or other type of information associated with the conference session. Conference system 402 may support the exchange of user communications using traditional phone calls and/or communications exchanged via client software executing on endpoints 403-406). Conference system 402 may support impromptu communications (e.g., one of participants 443-446 initiating an unplanned communication session with one or more other participants), although the examples below are concerned with the ability of calendar system 401 to schedule conference sessions ahead of time via meeting invites.

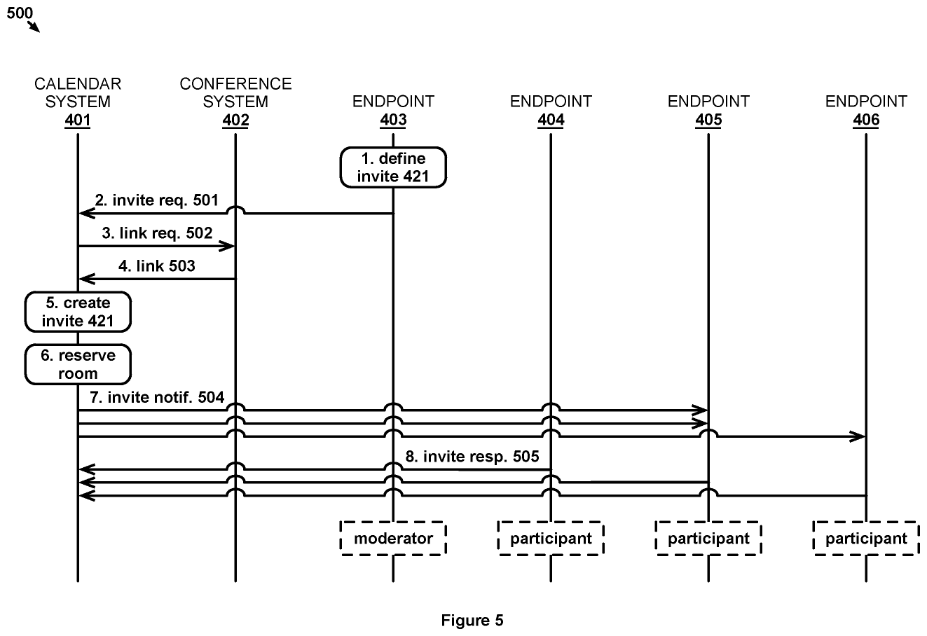

FIG. 5 illustrates operational scenario 500 to change the moderator on an existing meeting invite. In operational scenario 500, participant 443 defines meeting invite 421 at step 1 via user input into endpoint 403. For example, meeting invite 421 may open a calendar application executing on endpoint 403 and instruct the calendar application to create a new meeting invite. Participant 443 at least defines when the meeting will occur, that participants 443-446 will all be participants in the meeting, and that the meeting will include information for accessing a communication session provided by conference system 402. In this example, participant 443 also indicates that participant 443 would like to reserve a meeting room for the meeting so that at least participant 443 can participate from the meeting room. In some examples, participant 443 may also need to define themselves as being the moderator of meeting invite 421 but, in this example, participant 443 is designated as the moderator due to participant 443 creating meeting invite 421.

Once meeting invite 421 has been defined, endpoint 403 transfers invite request 501 at step 2 to calendar system 401 so that calendar system 401 can create meeting invite 421. Invite request 501 includes information necessary for calendar system 401 to create the meeting invite 421 as defined by participant 443. In other examples, endpoint 403 may transfer information defining meeting invite 421 in pieces rather than in a single request. For instance, calendar system 401 may be able to provide feedback regarding whether certain aspects of meeting invite 421 are allowed (e.g., may indicate whether a particular time slot is available, whether a particular participant is available in that time slot, whether a requested meeting room is available, or some other relevant feedback), which provides participant 443 with the opportunity to redefine meeting invite 421 in order to compensate for that feedback (e.g., to change the meeting time to accommodate one of the participant's schedules).

Upon receiving invite request 501, calendar system 401 recognizes that a communication session is requested for the meeting of meeting invite 421 and transfers conference link request 502 at step 3 to conference system 402. Conference link request 502 requests conference link 503, which is a Uniform Resource Locator (URL) to access a conference bridge associated with participant 443 for a communication session that will be facilitated by conference system 402. In response to receiving conference link request 502, conference system 402 transfers conference link 503 to calendar system 401. In some examples, conference system 402 may also provide dial-in and bridge identifier information so that calendar system 401 can include that information in meeting invite 421 for participants that may not be able to join a communication session using conference link 503 (e.g., can only join by phone rather than an application or web interface).

Calendar system 401 creates meeting invite 421, as defined by participant 443, in participant 443's calendar at step 5 and includes conference link 503 in meeting invite 421. Calendar system 401 also reserves the meeting room requested by participant 443 for meeting invite 421 at step 6. In this example, calendar system 401 also handles room reservations but, in other examples, a separate system may handle room reservations and calendar system 401 would communicate with that separate system to arrange the room reservation. If calendar system 401 was not able to previously provide feedback about room availability, calendar system 401 may at this point also notify participant 443 via endpoint 403 whether a requested room is available so that participant 443 can pick a different room or time for meeting invite 421 accordingly.

After creating meeting invite 421, calendar system 401 notifies other participants by transferring an invite notification 504 at step 7 to each of endpoints 404-406. Endpoints 404-406 then each respond at step 8 with an invite response 505 upon each of their respective participants 444-446 accepting meeting invite 421 from calendar system 401. In other examples, participants may respond by declining meeting invite 421, indicating that they may attend, or failing to respond. In those examples, calendar system 401 may or may not consider participants with those alternative responses to be participants. After receiving an invite response 505 from participants 444-446, calendar system 401 includes meeting invite 421 in the respective calendars of participants 444-446.

The above example only provides one exemplary sequence for creating meeting invite 421. In other examples, calendar system 401 and endpoints 403-406, may perform different steps and may perform those steps in a different order depending on how those systems are configured to handle meeting invites (e.g., one calendar service provider may perform differently than another). Regardless of the steps taken to create meeting invite 421, the creation of meeting invite 421 results in participant 443 being the moderator of meeting invite 421 and participants 444-446 being regular participants. Calendar system 401, therefore, grants participant 443 with moderator-level permissions to access meeting invite 421. The moderator level-permissions in this case allow participant 443 to change moderators of meeting invite 421 without having to delete meeting invite 421 but may also grant participant 443 the ability to modify meeting invite 421 in other ways not afforded to the other participants.

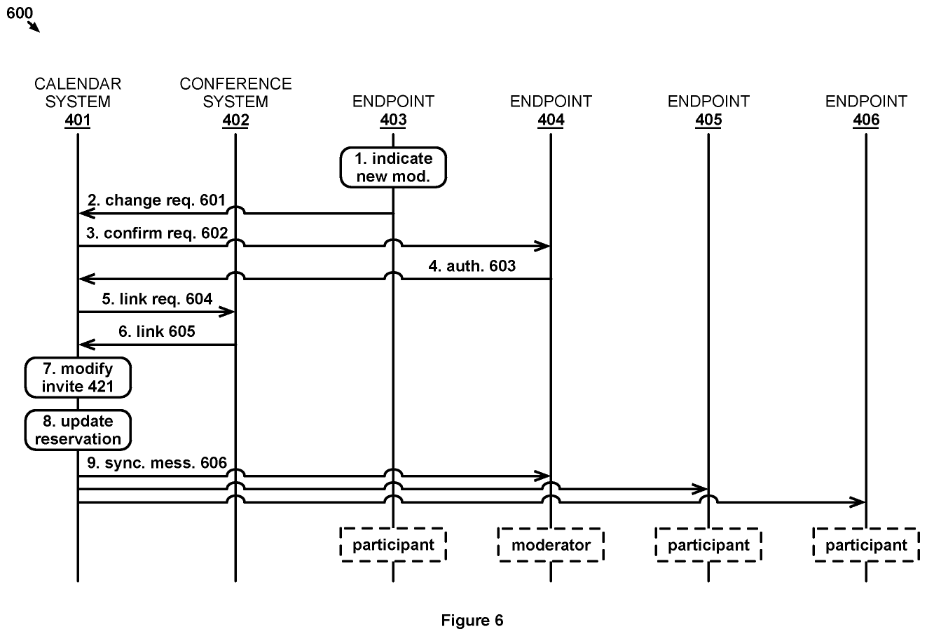

FIG. 6 illustrates operational scenario 600 to change the moderator on an existing meeting invite. Operational scenario 600 occurs after completion of operational scenario 500 at a time when participant 443 determines that they want to change the moderator of meeting invite 421 to someone else. For instance, another obligation may have arisen that will cause participant 443 to be late to the meeting scheduled by meeting invite 421. Since meeting invite 421 also schedules participant 443 to be the moderator of the resulting communication session facilitated by conference system 402 due to conference link 503 being associated with participant 443, the communication session may not be able to commence until participant 443 joins. Therefore, participant 443 wishes to change the moderator of meeting invite 421 to participant 444, who plans to be on time to the meeting.

To change the moderator of meeting invite 421 to participant 444, participant 443 provides user input into endpoint 403 at step 1 that indicates that participant 443 wants to change the moderator of meeting invite 421 to participant 444. For example, participant 443 may open a graphical interface in a calendar application on endpoint 403 and indicate through the interface that participant 443 wants to edit the moderator of meeting invite 421. The graphical interface may indicate the current moderator of meeting invite 421 or may presume that participant 443 knows that they are the current moderator. The graphical interface may then allow participant 443 to select one of participants 444-446 that should become the new moderator (i.e., participant 444 in this example). In other examples, the new moderator may not already be a participant on meeting invite 421 and participant 443 would therefore have to explicitly identify the desired participant using whatever identification information is needed by calendar system 401 to identify the participant (e.g., name, email address, username, or other type of identifier). In some examples, participant 444 may further indicate whether they wish to remain a participant on meeting invite 421 despite no longer being the moderator.

Endpoint 403 transfers moderator change request 601 at step 2 to calendar system 401. Moderator change request 601 indicates that the moderator of meeting invite 421 should be changed to participant 444 in a protocol used by calendar system 401. Before modifying meeting invite 421 to change the moderator thereof, calendar system 401 transfers change confirmation request 602 at step 3 to endpoint 404. Change confirmation request 602 causes endpoint 404 to request confirmation from participant 444 that participant 444 is willing to allow the change. For example, endpoint 404 may display a popup notification requesting that participant 444 provide input allowing or denying the change. In this case, participant 444 chooses to allow the change and endpoint 404 transfers change authorization 603 at step 4 to calendar system 401. Change authorization 603 indicates to calendar system 401 that participant 444 has authorized the change of moderators to meeting invite 421 to participant 444. In other examples, participant 444 may deny the change, which may cause calendar system 401 to notify participant 443 of the denial through a message transferred to endpoint 403. Participant 443 can then choose a different participant to be the new moderator, change some other aspect of meeting invite 421 (e.g., change the time), or perform some other action in response to being notified of participant 444's denial.

Once the moderator change is authorized, calendar system 401 transfers conference link request 604 to conference system 402 at step 5 to request conference link 605, which is a URL to access a conference bridge associated with participant 443 for a communication session that will be facilitated by conference system 402. In response to receiving conference link request 604, conference system 402 transfers conference link 605 to calendar system 401. In some examples, conference system 402 may also provide dial-in and bridge identifier information so that calendar system 401 can include that information in meeting invite 421 for participants that may not be able to join a communication session using conference link 605. After receiving conference link 605, calendar system 401 modifies meeting invite 421 at step 7 to indicate that participant 444 is now the moderator of meeting invite 421 and replaces conference link 503 with conference link 605. Replacing conference link 503 with conference link 605 causes participant 444 to also be the moderator of the conference session established when participants 443-446 select conference link 605 to begin the conference session. Using conference link 605 instead of conference link 503 for the communication session avoids issues that may be caused by participant 443 joining the conference session late, which may be the case if conference link 503 associated with participant 443 was still used. Meeting invite version 700 and meeting invite version 800 below provide an example for how calendar system 401 may modify meeting invite 421.

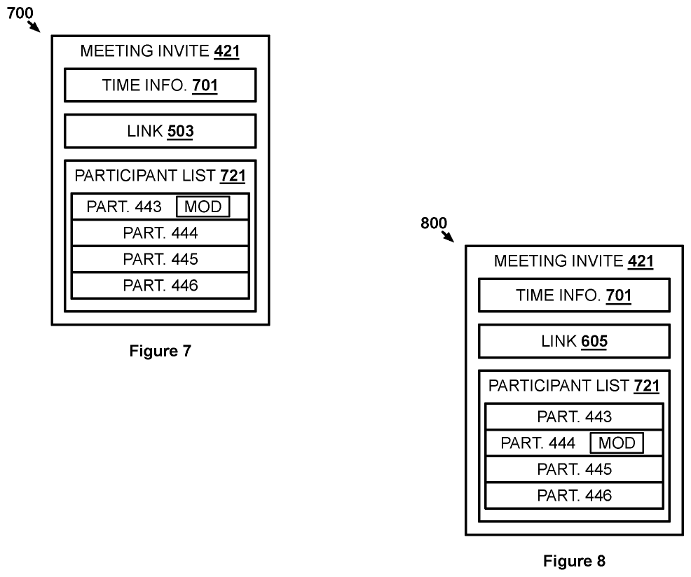

FIG. 7 illustrates meeting invite version 700 for changing the moderator on an existing meeting invite. Meeting invite version 700 is a visual representation of the data for meeting invite 421 after completion of operational scenario 500. Meeting invite 421 in meeting invite version 700 includes time information 701, conference link 503, and participants list 721. Time information 701 indicates a block of time scheduled for a meeting in accordance with meeting invite 421. For example, time information 701 may indicate a date in which the meeting will be held, a start time, and an end time for the meeting. Participants list 721 indicates that participants 443-446 are the participants confirmed for meeting invite 421. In this example, meeting invite 421 indicates which of participants 443-446 is the moderator for meeting invite 421 (i.e., participant 443) using a data flag in participants list 721. Meeting invites in other examples may indicate which participant is the moderator in other ways.

FIG. 8 illustrates meeting invite version 800 for changing the moderator on an existing meeting invite. Meeting invite version 800 is a visual representation of the data for meeting invite 421 after calendar system 401 modifies meeting invite 421 in operational scenario 600. Meeting invite 421 in meeting invite version 800 includes time information 701, conference link 605 and participants list 721. Time information 701 is the same as in meeting invite version 700 because calendar system 401 did not modify the timing of meeting invite 421. Conference link 605 is now included instead of conference link 503 because conference link 605 is associated with the new moderator, participant 444. Likewise, while participants list 721 still indicates participants 443-446 as being the participants of meeting invite 421, the data flag indicating which of participant 443-446 is the moderator of meeting invite 421 is now associated with participant 444 rather than participant 443. Thus, after calendar system 401 modifies meeting invite 421 to create meeting invite version 800, meeting invite 421 is similar, if not identical, to what meeting invite 421 would have been had participant 444 created meeting invite 421 initially.

Referring back to operational scenario 600, calendar system 401 updates the meeting room reservation at step 8 to indicate that the reservation is now associated with participant 444 instead of participant 443. In this example, calendar system 401 handles room reservations itself but, in other examples, calendar system 401 may communicate with a room reservation system to associate the room reservation with participant 444. In some examples, the room reservation may be indicated in meeting invite 421 and, therefore, require modification of the data representing meeting invite 421. In further examples, if the reservation association cannot be changed from participant 443, calendar system 401 may allow participant 443 to remain on the room reservation to avoid cancelation of the room reservation.

Calendar system 401 transfers synchronization message 606 to each of endpoints 404-406 at step 9 so that endpoints 404-406 can update local versions of meeting invite 421 to indicate the change in moderator. Additionally, endpoints 404-406 may notify their respective participants 444-446 about the moderator change in response to receiving synchronization message 606. Synchronization message 606 may also be transferred to endpoint 403 but, in this example, since endpoint 403 received the initial change input from participant 443, endpoint 403 is presumed to already have updated data for meeting invite 421. Upon completion of operational scenario 600, meeting invite 421 is represented across calendar system 401 and endpoints 403-406 as having participant 444 as the moderator and participants 443, 445-446 as normal participants.

Though the examples above describe the original moderator of meeting invite 421 being replaced, some calendar systems may allow multiple moderators in some examples. Thus, in one of those examples, meeting invite 421 may be modified to include participant 444 as a moderator in addition to participant 443 also being a moderator. Moderator-level permissions are therefore afforded to both participant 443 and participant 444 rather than only to one.

Additionally, the examples above describe how the moderator may be changed on a meeting invite for a non-repeating meeting. Calendar system 401 may also support meeting invites that repeat periodically as defined by the meeting creator (i.e., participant 443 for meeting invite 421) or moderator. For example, meeting invite 421 may be defined such that it repeats bi-weekly (e.g., every other Wednesday at 11:00 am). If meeting invite 421 was a repeating invite, the operational scenarios above may change the moderator of meeting invite 421 as a whole (i.e., every instance of meeting invite 421 moving forward) or the moderator change may apply to a specific subset of the future instances of meeting invite 421. For instance, participant 443 may be going on a month-long vacation and may want two meetings of bi-weekly meeting invite 421 that will occur during that vacation to be handled by a different moderator. When indicating that participant 444 as the new moderator via input into endpoint 403, participant 443 would indicate that participant 444 should be the new moderator of the two specific instances of meeting invite 421 that occur over the vacation. In response to the instructions from participant 443, calendar system 401 would change the moderator, and corresponding link, to participant 444 of only the two instances indicated by participant 443. The remaining instances of meeting invite 421 would remain the same with participant 443 as moderator.

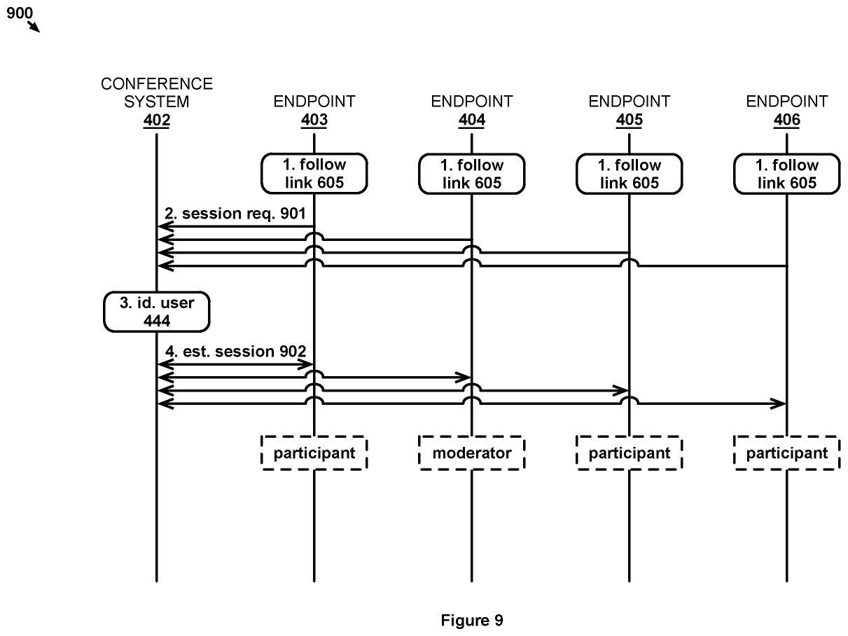

FIG. 9 illustrates operational scenario 900 to change the moderator on an existing meeting invite. In operational scenario 900, during the time prescribed by meeting invite 421, endpoints 403-406 all follow conference link 605 at step 1 to initiate a connection to conference system 402 for a conference session. For example, each of participants 443-446 may select conference link 605 via a calendar application which triggers each of endpoints 403-406 to imitate the connection. While the respective steps of operational scenario 900 are shown to be occurring at substantially the same time for each of endpoints 403-406, each endpoint may join the conference session at different times, although the steps would be the same (e.g., participant 443 may join late, as mention might occur in an example above, when then conference session was already established between endpoints 404-406.

In response to following conference link 605, endpoints 403-406 each transfer a conference session request 901 at step 2 to conference system 402. Conference system 402 then waits until it can identify participant 444, who is the moderator associated with conference link 605, at step 3 before proceeding with establishment of the conference session. For instance, conference system 402 may wait until it receives conference session request 901 from endpoint 404 before proceeding. In other examples, conference system 402 may allow participants other than participant 444 to join the conference session while they wait for participant 444 but may then require that participant 444 join within a threshold period of time in order for the conference session to continue. In this case, after identifying participant 444, session establishment messages 902 exchanges session establishment messages 902 with endpoints 403-406 at step 4 to establish a conference session between endpoints 403-406 with participant 444 as the moderator of that conference session. Participants 443-446 can then exchange user communications (e.g., voice and/or video) with each other over the established communication session. As the moderator, participant 444 may be allowed to mute other participants, share endpoint 404's screen, allow other participants to share their screen, or perform some other action that may be reserved for a moderator.

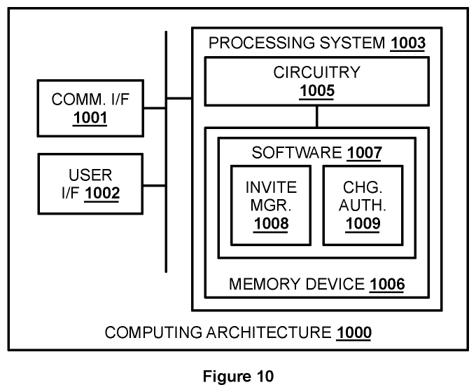

FIG. 10 illustrates computing architecture 1000 for changing the moderator on an existing meeting invite. Computing architecture 1000 is an example computing architecture for meeting control system 101, calendar system 401, and conference system 402, although systems 101, 401, and 402 may use alternative configurations. A similar architecture may also be used for other systems described herein (e.g., endpoints 102-204 and 403-406), although alternative configurations may also be used. Computing architecture 1000 comprises communication interface 1001, user interface 1002, and processing system 1003. Processing system 1003 is linked to communication interface 1001 and user interface 1002. Processing system 1003 includes processing circuitry 1005 and memory device 1006 that stores operating software 1007.

Communication interface 1001 comprises components that communicate over communication links, such as network cards, ports, RF transceivers, processing circuitry and software, or some other communication devices. Communication interface 1001 may be configured to communicate over metallic, wireless, or optical links. Communication interface 1001 may be configured to use TDM, IP, Ethernet, optical networking, wireless protocols, communication signaling, or some other communication format—including combinations thereof.

User interface 1002 comprises components that interact with a user. User interface 1002 may include a keyboard, display screen, mouse, touch pad, or some other user input/output apparatus. User interface 1002 may be omitted in some examples.

Processing circuitry 1005 comprises microprocessor and other circuitry that retrieves and executes operating software 1007 from memory device 1006. Memory device 1006 comprises a computer readable storage medium, such as a disk drive, flash drive, data storage circuitry, or some other memory apparatus. In no examples would a storage medium of memory device 1006 be considered a propagated signal. Operating software 1007 comprises computer programs, firmware, or some other form of machine-readable processing instructions. Operating software 1007 includes invite manager module 1008 and change authorization module 1009. Operating software 1007 may further include an operating system, utilities, drivers, network interfaces, applications, or some other type of software. When executed by processing circuitry 1005, operating software 1007 directs processing system 1003 to operate computing architecture 1000 as described herein.

In particular, invite manager module 1008 directs processing system 1003 to receive a first request to change a moderator of a first meeting invite. The first meeting invite includes two or more participants and the two or more participants include a first moderator indicated for the first meeting invite. Change authorization module 1009 directed processing system 1003 to determine that the first request is associated with a user allowed to change the moderators of the first meeting invite. In response to the user being allowed, invite manager module 1008 directs processing system 1003 to modify the first meeting invite to indicate a second moderator for the first meeting invite and include the second moderator in the two or more participants.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method for changing moderators of a meeting invite, the method comprising:
in a meeting control system:
receiving a first request to change a moderator of a first meeting invite, wherein the first meeting invite includes two or more participants, and wherein the two or more participants include a first moderator indicated for the first meeting invite;
in response to determining that the first request is associated with a user allowed to change the moderators of the first meeting invite, modifying the first meeting invite to indicate a second moderator for the first meeting invite; and
including the second moderator in the two or more participants.

2. The method of claim 1, further comprising:
synchronizing the first meeting invite with endpoints of the two or more participants.

3. The method of claim 1, further comprising:
notifying the two or more participants about the second moderator.

4. The method of claim 1, further comprising:
establishing a first communication session between respective endpoints of the two or more participants.

5. The method of claim 1, further comprising:
after modifying the first meeting invite, removing the first moderator from the two or more participants of the first meeting invite.

6. The method of claim 1, wherein, after modifying the first meeting invite, the first meeting invite indicates both the first moderator and the second moderator are the moderators for the first meeting invite.

7. The method of claim 1, further comprising:
before modifying the first meeting invite, receiving confirmation of the first request from the second moderator.

8. The method of claim 1, further comprising:
providing moderator-level permissions for accessing the first meeting invite to the second moderator.

9. The method of claim 1, wherein the user is the first moderator.

10. The method of claim 1, wherein the user is not one of the two or more participants.

11. An apparatus for a meeting control system to change moderators of a meeting invite, the apparatus comprising:
one or more computer readable storage media;
a processing system operatively coupled with the one or more computer readable storage media; and
program instructions stored on the one or more computer readable storage media that, when read and executed by the processing system, direct the processing system to:
receive a first request to change a moderator of a first meeting invite, wherein the first meeting invite includes two or more participants, and wherein the two or more participants include a first moderator indicated for the first meeting invite;
in response to determining that the first request is associated with a user allowed to change the moderators of the first meeting invite, modify the first meeting invite to indicate a second moderator for the first meeting invite; and
include the second moderator in the two or more participants.

12. The apparatus of claim 11, wherein the program instructions further direct the processing system to:
synchronize the first meeting invite with endpoints of the two or more participants.

13. The apparatus of claim 11, wherein the program instructions further direct the processing system to:
notify the two or more participants about the second moderator.

14. The apparatus of claim 11, wherein the program instructions further direct the processing system to:
establish a first communication session between respective endpoints of the two or more participants.

15. The apparatus of claim 11, wherein the program instructions further direct the processing system to:
after the first meeting invite is modified, remove the first moderator from the two or more participants of the first meeting invite.

16. The apparatus of claim 11, wherein, after the first meeting invite is modified, the first meeting invite indicates both the first moderator and the second moderator are the moderators for the first meeting invite.

17. The apparatus of claim 11, wherein the program instructions further direct the processing system to:
before the first meeting invite is modified, receive confirmation of the first request from the second moderator.

18. The apparatus of claim 11, wherein the program instructions further direct the processing system to:
provide moderator-level permissions for accessing the first meeting invite to the second moderator.

19. The apparatus of claim 11, wherein the user is the first moderator.

20. One or more computer readable storage media having program instructions stored thereon for changing moderators of a meeting invite, the program instructions, when read and executed by a processing system, direct the processing system to:
receive a first request to change a moderator of a first meeting invite, wherein the first meeting invite includes two or more participants, and wherein the two or more participants include a first moderator indicated for the first meeting invite;
in response to determining that the first request is associated with a user allowed to change the moderators of the first meeting invite, modify the first meeting invite to indicate a second moderator for the first meeting invite; and
include the second moderator in the two or more participants.
